(19) United States
(12) Patent Application Publication
(10) Pub. No.: US 2014/0247398 A1
(43) Pub. Date: Sep. 4, 2014

(54) Display

(71) Applicant: Funai Electric Co., Ltd., Osaka (JP)

(72) Inventor: Atsushi KAKIMOTO, Daito-shi (JP)

(73) Assignee: Funai Electric Co., Ltd., Osaka (JP)

(21) Appl. No.: 14/173,254

(22) Filed: Feb. 5, 2014

(30) Foreign Application Priority Data
Mar. 1, 2013 (JP) 2013-041098

(51) Int. Cl. F21V 8/00

(52) U.S. Cl. CPC G02B 6/0055
USPC 348/729; 362/633

(57) ABSTRACT

A display including a display body, a display portion, a first resin frame including a frame-shaped inner side surface having high light reflectance, a light source and a light guide formed in a substantially rectangular shape, having a light incident side surface consisting of a side surface opposed to the light source, and arranged on the first resin frame in a state where three side surfaces other than the light incident side surface are in contact with the inner side surface of the first resin frame or opposed to a portion close to the inner side surface of the first resin frame.

### BACKGROUND OF THE INVENTION

1. Field of the Invention

The present invention relates to a display, and more particularly, it relates to a display including a light guide.

2. Description of the Background Art

A display including a light guide is known in general, as disclosed in Japanese Patent Laying-Open No. 2000-284282, for example.

The aforementioned Japanese Patent Laying-Open No. 2000-284282 discloses a liquid crystal display (display) including a liquid crystal display body (display body), a liquid crystal panel (display portion) arranged on a front surface side of the liquid crystal display body for displaying an image, a panel support arranged on a rear surface side of the liquid crystal display body, formed in a substantially rectangular shape and including a frame-shaped inner side surface having high light reflectance, and light sources provided on right and left sides of the liquid crystal display body for supplying light to the liquid crystal panel. This liquid crystal display further includes a light guide formed in a substantially rectangular shape. This light guide has outer end surfaces (right and left outer side surfaces) provided on right and left end portions thereof for receiving light emitted from the right and left light sources respectively. The light sources are arranged on a rear surface side of the light guide on the right and left sides of the liquid crystal display body, and configured to emit the light toward the front surface side of the liquid crystal display body. A surface portion substantially perpendicularly reflecting the light emitted frontward from the light sources toward the directions of the outer end surfaces of the light guide is provided on the panel support in the vicinity of the outer end surfaces of the light guide.

In the liquid crystal display described in the aforementioned Japanese Patent Laying-Open No. 2000-284282, however, the light sources are arranged on the rear surface side of the light guide and hence the anteroposterior thickness of the liquid crystal display is disadvantageously increased.

### SUMMARY OF THE INVENTION

The present invention has been proposed in order to solve the aforementioned problem, and an object of the present invention is to provide a display capable of suppressing reduction in light emission efficiency of a display portion without providing a dedicated reflector on a light guide while suppressing increase in the anteroposterior thickness thereof.

A display according to an aspect of the present invention includes a display body, a display portion arranged on a front surface side of the display body for displaying an image, a first resin frame arranged on a rear surface side of the display body, formed in a substantially rectangular shape and including a frame-shaped inner side surface having high light reflectance, a light source supplying light to the display portion and a light guide formed in a substantially rectangular shape, having a light incident side surface consisting of a side surface opposed to the light source for receiving the light emitted from the light source, and arranged on the first resin frame in a state where three side surfaces other than the light incident side surface are in contact with the inner side surface of the first resin frame or opposed to a portion close to the inner side surface of the first resin frame.

As hereinabove described, the display according to the aspect of the present invention is provided with the light guide formed in a substantially rectangular shape and having the light incident side surface consisting of the side surface opposed to the light source for receiving the light emitted from the light source so that the light source can be arranged on a side portion of the light guide, whereby increase in the anteroposterior thickness of the display body can be suppressed, dissimilarly to a case where the light source is arranged on the rear surface side of the light guide. Further, the display is provided with the first resin frame including the inner side surface having high light reflectance and the light guide arranged on the first resin frame in the state where the three side surfaces other than the light incident side surface are in contact with the inner side surface of the first resin frame or opposed to the portion close to the inner side surface of the first resin frame so that the inner side surface having high light reflectance included in the first resin frame functions also as a reflector inhibiting light incident upon the light guide from leaking out of the side surfaces thereof, whereby reduction in light emission efficiency of the display portion can be suppressed while reducing the number of components without separately providing a dedicated reflector for inhibiting the light from leaking out of the side surfaces of the light guide. In this display, therefore, reduction in the light emission efficiency of the display portion can be suppressed while suppressing increase in the anteroposterior thickness of the display and reducing the number of components without separately providing a dedicated reflector on the light guide. Further, the light guide is arranged on the first resin frame in the state where all of the three side surfaces of the light guide other than the light incident side surface are in contact with the inner side surface of the first resin frame or opposed to the portion close to the inner side surface of the first resin frame, whereby the light can be effectively inhibited from leaking out of the side surfaces of the light guide as compared with a case where the light guide is arranged on the first resin frame while only two side surfaces or one side surface is in contact with the inner side surface of the first resin frame or opposed to the portion close to the inner side surface of the first resin frame. Thus, reduction in the light emission efficiency of the display portion can be suppressed, whereby the number of light sources can be reduced.

In the display according to the aforementioned aspect, at least the inner side surface of the first resin frame is preferably made of a white or quasi-white material. According to this structure, the light incident upon the light guide can be effectively inhibited from leaking out of the side surfaces of the light guide by increasing the light reflectance of the inner side surface.

In the display according to the aforementioned aspect, the resin frame preferably has a bottom surface covering the rear surface of the display body thereby constituting a rear frame, the rear frame preferably includes a frame-shaped projecting portion protruding toward the front surface side along an edge portion of the bottom surface, and the frame-shaped inner side surface of the first resin frame is preferably included in the frame-shaped projecting portion. According to this structure, the first resin frame functions also as the rear frame covering the rear surface of the display body, whereby no dedicated frame covering the rear surface of the display body may be separately provided and the number of components can be reduced.

In this case, the inner side surface of the frame-shaped projecting portion is preferably formed to extend substantially parallelly with the side surfaces of the light guide in the anteroposterior direction. According to this structure, the light guide can be easily arranged on the first resin frame while bringing the side surfaces of the light guide into contact with the inner side surface of the first resin frame or opposing the same to the portion close to the inner side surface of the first resin frame.

In the aforementioned structure in which the first resin frame has the bottom surface, the inner side surface of the frame-shaped projecting portion and the side surfaces of the light guide are preferably configured to come into surface contact with each other. According to this structure, the side surfaces of the light guide and the inner side surface of the first resin frame can be brought into contact with each other in a stable state.

In the aforementioned structure in which the first resin frame has the bottom surface, the bottom surface of the first resin frame and the frame-shaped projecting portion are preferably integrally formed on the first resin frame. According to this structure, the number of components can be reduced as compared with a case where the bottom surface and the frame-shaped projecting portion are separately provided.

In the aforementioned structure in which the first resin frame has the bottom surface, the frame-shaped projecting portion preferably has a thickness larger than the thickness of the light guide in the anteroposterior direction. According to this structure, the whole side surfaces of the light guide can be brought into contact with the inner side surface of the first resin frame or opposed to the portion close to the inner side surface of the first resin frame, whereby the light incident upon the light guide can be reliably inhibited from leaking out of the side surfaces of the light guide.

In the aforementioned structure in which the first resin frame has the bottom surface, the light guide preferably includes a light-emitting surface provided on the front surface of the light guide to be substantially orthogonal to the light incident side surface, and the light-emitting surface is preferably arranged rearward beyond the front surface of the frame-shaped projecting portion of the first resin frame in the anteroposterior direction. According to this structure, light advancing in the light guide before emission from the light-emitting surface can be effectively inhibited from leaking out of the side surfaces of the light guide.

In the aforementioned structure in which the first resin frame has the bottom surface, the thickness of the frame-shaped projecting portion in the extensional direction of the bottom surface is preferably larger than the thickness of the light guide in the anteroposterior direction. According to this structure, rigidity of the frame-shaped projecting portion can be easily improved.

The display according to the aforementioned aspect preferably further includes a second resin frame having high light absorptivity for fixing the light guide to the display body, and the second resin frame preferably includes a covering portion covering a position where at least one of the three side surfaces of the light guide other than the light incident side surface is arranged in the state in contact with the inner side surface of the first resin frame or opposed to the portion close to the inner side surface of the first resin frame from the front surface side. According to this structure, the covering portion of the second resin frame can shield light even if the same leaks out of the side surfaces of the light guide, whereby the leaking light can be inhibited from leaking toward the front surface side of the display body. Thus, the display portion can be inhibited from reduction in visual recognizability.

In this case, at least the covering portion of the second resin frame is preferably made of a black or quasi-black material. According to this structure, the covering portion of the second resin frame made of the black or quasi-black material can more effectively shield light, whereby the display portion can be further inhibited from reduction in visual recognizability.

In the aforementioned structure including the second resin frame, the second resin frame is preferably formed in a frame shape, and configured to cover the front surface sides of the side surfaces of the light guide formed in a substantially frame shape. According to this structure, the frame-shaped second resin frame can shield light on the whole areas of the front surface sides of the side surfaces of the light guide formed in a substantially frame shape, whereby the light can be effectively inhibited from leaking toward the front surface side of the display body.

In the aforementioned structure including the second resin frame, the display preferably further includes a bezel of metal covering the second resin frame from the front surface side, and the bezel is preferably formed to extend from the front surface side of the second resin frame up to a portion close to the rear surface side of the light guide in the anteroposterior direction. According to this structure, the bezel made of metal can inhibit the light from leaking out of the second resin frame, whereby the image displayed on the display portion can be prevented from difficulty in visual recognizability.

In the aforementioned structure including the second resin frame, the first resin frame preferably includes a bottom surface covering the rear surface of the display body and a frame-shaped projecting portion protruding toward the front surface side along an edge portion of the bottom surface, the front surface of the frame-shaped projecting portion of the first resin frame is preferably formed in a planar surface shape, and a portion of the second resin frame corresponding to a front surface of the frame-shaped projecting portion of the first resin frame is preferably at least partially formed in a planar surface shape. According to this structure, light can be inhibited from leaking out of a clearance between the second resin frame and the frame-shaped projecting portion of the first resin frame by bringing the second resin frame and the frame-shaped projecting portion of the first resin frame into contact with each other in a stable state.

In the display according to the aforementioned aspect, the light guide and the first resin frame are preferably made of materials having substantially identical linear expansion coefficients, [the inner side surface of the first resin frame preferably has a width larger than the thickness of the light guide plate in the anteroposterior direction of the display body,] and the light guide is preferably arranged on the first resin frame in a state where substantially the whole areas of the three side surfaces other than the light incident side surface are in contact with the inner side surface of the first resin frame or opposed to the portion close to the inner side surface of the first resin frame. According to this structure, the light guide and the first resin frame expand or contract at substantially identical rates when the same are influenced by heat so that neither the light guide nor the first resin frame remarkably expands to one-sidedly urge the other, whereby the light guide and the first resin frame can be inhibited from misregistration. Further, the light can be further inhibited from leaking out of the three side surfaces of the light guide other than the light incident side surface by bringing substantially the whole areas of the three side surfaces other than the light incident side surface into contact with the inner side surface of the first resin frame or opposing the former to the latter.

In the aforementioned structure in which at least the covering portion of the second resin frame is made of the black or quasi-black material, the reflectance of the first resin frame is preferably higher than the reflectance of the covering portion of the second resin frame. According to this structure, the first resin frame can more reliably inhibit the light incident upon the light guide from leaking out of the side surfaces of the light guide while the covering portion of the second resin frame can more reliably shield the light, whereby the display portion can be further inhibited from reduction in visual recognizability.

In the aforementioned structure including the second resin frame, the second resin frame is preferably formed to extend up to a portion close to an outer edge portion of the first resin frame. According to this structure, the area of the second resin frame can be increased, whereby the second resin frame can reliably shield light even if the light leaks out of the side surfaces of the light guide.

The display according to the aforementioned structure is preferably a television set including a receiver receiving television broadcasting. The present invention is also applicable to a television set.

### Effect of the Invention

According to the present invention, as hereinabove described, reduction in the light emission efficiency of the display portion can be suppressed without providing a dedicated reflector on the light guide, while suppressing increase in the anteroposterior thickness of the display.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates the overall structure of a TV according to an embodiment of the present invention;

FIG. 2 illustrates an arranged state of a light guide and a white resin frame in the TV according to the embodiment of the present invention;

FIG. 3 illustrates a portion where the light guide of the TV according to the embodiment of the present invention and an LED are opposed to each other in an enlarged manner;

FIG. 4 illustrates a black resin frame arranged on the white resin frame of the TV according to the embodiment of the present invention;

FIG. 5 is a sectional view taken along the line 500-500 in FIG. 1;

FIG. 6 is a sectional view taken along the line 600-600 in FIG. 1;

FIG. 7 illustrates a black resin frame arranged on a white resin frame of a TV according to a first modification of the embodiment of the present invention;

FIG. 8 illustrates a black resin frame arranged on a white resin frame of a TV according to a second modification of the embodiment of the present invention; and

FIG. 9 illustrates a white resin frame of a TV according to a third modification of the embodiment of the present invention.

### DESCRIPTION OF THE PREFERRED EMBODIMENTS

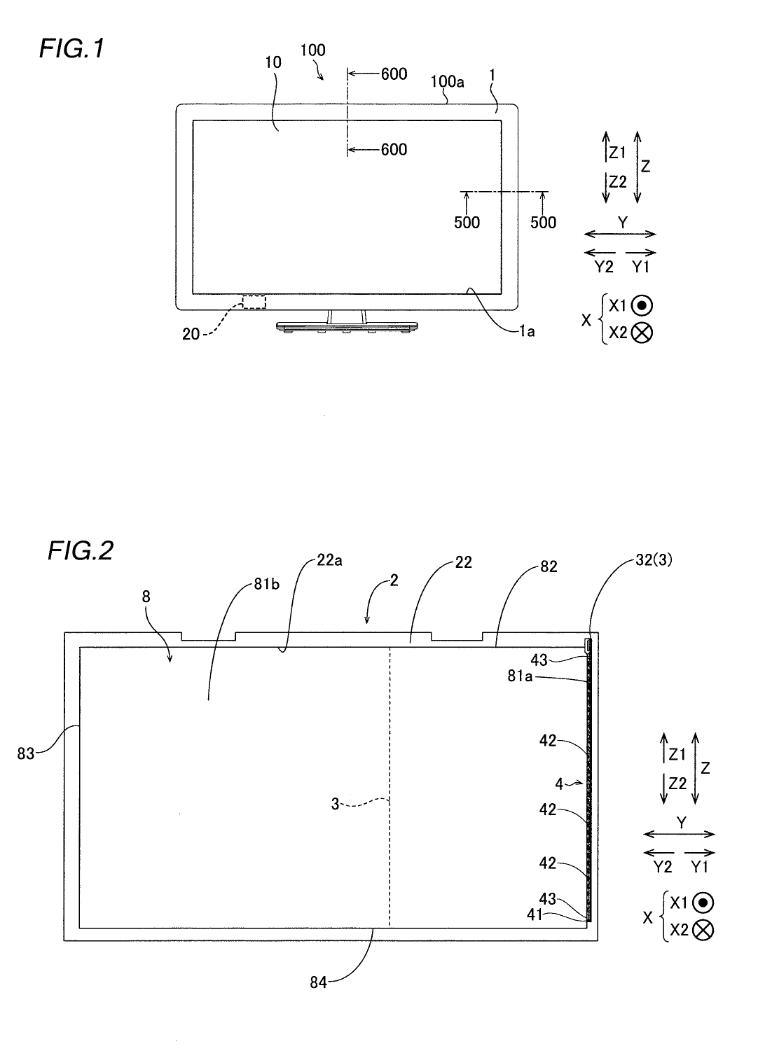

The structure of a TV (television set) 100 according to an embodiment of the present invention is now described with reference to FIGS. 1 to 6. The TV 100 is an example of the “display” in the present invention.

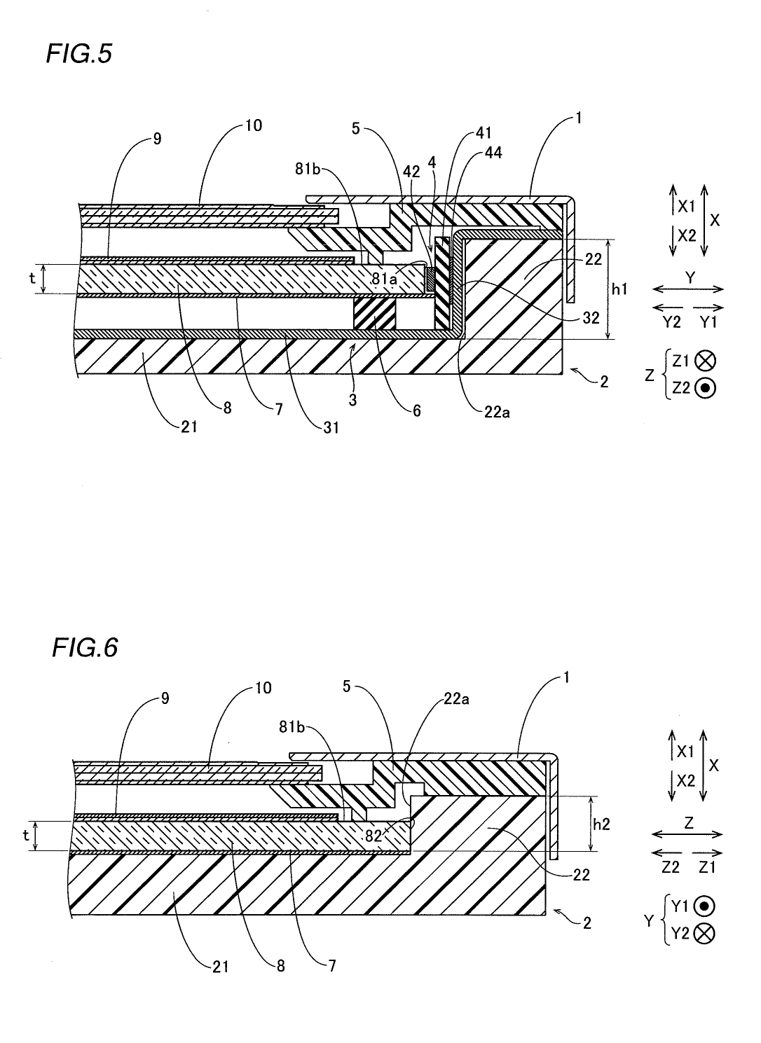

The TV 100 according to the embodiment of the present invention includes a bezel 1 having an opening 1a and a white resin frame 2 (see FIG. 2), as shown in FIG. 1. The bezel 1 is configured to cover a front surface side (along arrow X1) of a TV body 100a. The bezel 1, made of SECC (steel, electrically chromate coated: electrogalvanized steel), is formed in a frame shape. The bezel 1 is so configured that a display portion 10 described later is exposed from the opening 1a thereof. The white resin frame 2 is arranged on a rear surface side (along arrow X2) of the TV body 100a, as shown in FIGS. 5 and 6. This white resin frame 2 is described in detail later. The TV 100 is configured to be capable of receiving broadcast signals by a receiving portion (see FIG. 1). The TV body 100a is an example of the “display body” in the present invention. The white resin frame 2 is an example of the “first resin frame” in the present invention.

A heat sink 3 and an LED module 4 including LEDs 42 are arranged in the TV 100, as shown in FIG. 5. Further, a black resin frame 5, a spacer 6 (see FIG. 5), a reflection sheet 7, a light guide 8, an optical sheet 9 and the display portion 10 are also arranged in the TV 100, as shown in FIGS. 5 and 6. The LEDs 42 are examples of the “light source” in the present invention. The black resin frame 5 is an example of the “second resin frame” in the present invention.

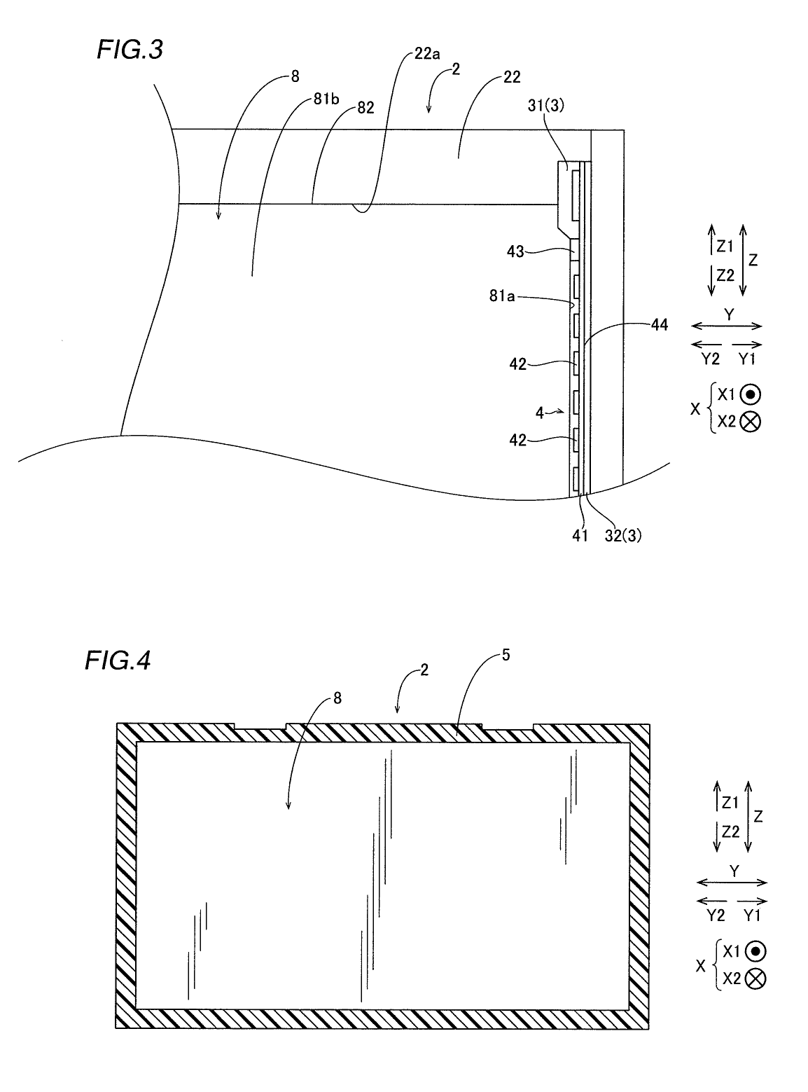

The heat sink 3 has a function of radiating heat from the LEDs 42. This heat sink 3 is made of metal (sheet metal). The heat sink 3 includes a heat sink body portion 31 and an LED substrate fixing portion 32, as shown in FIGS. 3 and 5. The white resin frame 2 is arranged on the rear surface side (along arrow X2) of the heat sink 3 (heat sink body portion 31), as shown in FIG. 5. The heat sink body portion 31 is formed in a planar surface shape, to extend in a direction Y. The heat sink 3 is formed to extend from a Y1-side end portion of the TV body 100a up to a portion close to a central portion in the direction Y, as shown in FIG. 2. The LED substrate fixing portion 32 is formed by substantially perpendicularly bending part of the heat sink 3 along arrow Y1 toward the front surface side (along arrow X1).

The LED module 4 is configured to be arranged on the right side (along arrow Y1) of the TV body 100a (see FIG. 1) as viewed from the front side, as shown in FIG. 2. The LED module 4 mainly includes an LED substrate 41 and the plurality of LEDs 42 mounted on the LED substrate 41, as shown in FIGS. 2, 3 and 5. The LEDs 42 are configured to supply light to the display portion 10 (see FIG. 1). The LED substrate 41 is provided with substrate spacers 43 keeping the distance between the LEDs 42 and a light incident side surface 81a of the light guide 8 constant, as shown in FIGS. 2 and 3. The substrate spacers 43 are provided in the vicinity of both end portions of the LED substrate 41 in a direction Z. A double-faced adhesive tape 44 for fixing the LED module 4 (LED substrate 41) to the heat sink 3 is provided on a surface of the LED substrate 41 along arrow Y1, as shown in FIGS. 3 and 5.

According to this embodiment, the black resin frame 5 is arranged on the front surface side (along arrow X1) of the white resin frame 2, as shown in FIGS. 4 to 6. This black resin frame 3 is made of a black material (resin), to have high light absorptivity. Light reflectance of the black resin frame 5 is lower than that of the white resin frame 2. In other words, the light reflectance of the white resin frame 2 is higher than that of the black resin frame 5. The black resin frame 5 is in the form of a frame (see FIG. 4) having a substantially rectangular shape. The black resin frame 5 is configured to fix the light guide 8 to the TV body 100a, as shown in FIGS. 5 and 6. The black resin frame 5 is arranged on a frame-shaped projecting portion (hereinafter referred to as a projecting portion) 22, described later, of the white resin frame 2. The black resin frame 5 is formed to extend up to a portion close to an outer edge portion of the white resin frame 2.

The spacer 6 is arranged on the rear surface side (along arrow X2) of the light guide 8, as shown in FIG. 5. This spacer 6 is arranged on a surface of the heat sink 3 along arrow X1 in the vicinity of the LED module 4. The spacer 6 is provided for arranging the light guide 8 on a prescribed position when fixing the same to the TV body 100a with the black resin frame 5.

The reflection sheet 7 is provided on the rear surface side (along arrow X2) of the light guide 8, as shown in FIGS. 5 and 6. The reflection sheet 7 has a function of inhibiting light from leaking toward the rear surface of the light guide 8.

The light guide 8 has a function of guiding light to the display portion 10. This light guide 8 is formed in a substantially rectangular shape, as shown in FIGS. 2 and 4. The light guide 8 has the light incident side surface 81a consisting of a side surface opposed to the LEDs 42 for receiving light emitted from the LEDs 42 and a light-emitting surface 81b emitting light. The light incident side surface 81a is configured to be opposed to the LEDs 42. On the other hand, the light-emitting surface 81b is provided on the front surface (along arrow X1) of the light guide 8. Further, the light-emitting surface 81b is configured to be substantially orthogonal to the light incident side surface 81b. In addition, the light-emitting surface 81b is arranged rearward (along arrow X2) beyond the front surface of the projecting portion 22 of the white resin frame 2 in the anteroposterior direction (direction X). The light guide 8 has a thickness t in the direction X, as shown in FIGS. 5 and 6. The light incident side surface 81a and side surfaces 82 to 84 of the light guide 8 are formed to be parallel to the anteroposterior direction (direction X) of the TV body 100a. The light guide 8 is made of acrylic resin.

The optical sheet 9 is arranged on the front surface side (along arrow X1) of the light guide 8, as shown in FIGS. 5 and 6. This optical sheet 9 has a function of efficiently transmitting the light emitted from the light-emitting surface 81b of the light guide 8 to the display portion 10.

The display portion 10 is arranged on the front surface side (along arrow X1) of the TV body 100a, and configured to display the image, as shown in FIGS. 1, 5 and 6. The display portion 10 is mainly constituted of liquid crystal cells.

According to this embodiment, the white resin frame 2 has a bottom surface 21 covering the rear surface (along arrow X2) of the TV body 100a as shown in FIGS. 5 and 6, thereby functioning as a rear frame. The white resin frame 2 is formed in a substantially rectangular shape (see FIG. 2), and includes a frame-shaped inner peripheral surface 22a having high light reflectance. The inner peripheral surface 22a is formed to protrude toward the front surface side (along arrow X1) along an edge portion of the bottom surface 21. More specifically, the white resin frame 2 is so formed that the edge portion of the bottom surface 21 has the projecting portion 22 protruding along arrow X1 in the form of a frame. The inner peripheral surface 21 is included in the inner surface side of the projecting portion 22. The bottom surface 21 and the projecting portion 22 of the white resin frame 2 are integrally formed on the white resin frame 2.

The TV 10 is so configured that the light guide 8 is arranged on an area surrounded by the projecting portion 22 (inner peripheral surface 22a), as shown in FIG. 2. The inner peripheral surface 22a of the projecting portion 22 is formed to extend substantially parallelly with the side surfaces 82 to 84 and the light incident side surface 81a of the light guide 8 in the anteroposterior direction (direction X). The inner peripheral surface 22a and the front surface (along arrow X1) of the projecting portion 22 are formed in planar surface shapes. The light guide 8 is arranged on the white resin frame 2 in a state where substantially the whole area of the side surface 82 other than the light incident side surface 81a is in contact with the inner peripheral surface 22a of the white resin frame 2, as shown in FIG. 6. More specifically, the inner peripheral surface 22a of the projecting portion 22 and the side surfaces 82 to 84 of the light guide 8 are configured to come into surface contact with each other. Further, the light guide 8 is arranged on the white resin frame 2 in a state where substantially the whole areas of the side surfaces 83 and 84 are in contact with the inner peripheral surface 22a of the white resin frame 2 similarly to the side surface 82.

The white resin frame 2 is made of a material (white acrylic resin, for example) having high light reflectance. In other words, the white resin frame 2 is made of a material hardly absorbing light. Further, the material for the white resin frame 2 has a linear expansion coefficient substantially identical to that of the light guide 8. The projecting portion 22 (inner peripheral surface 22a) of the white resin frame 2 has a width larger than the thickness t of the light guide 8 in the anteroposterior direction (direction X) of the TV body 100a, as shown in FIGS. 5 and 6. More specifically, the projecting portion 22 (inner peripheral surface 22a) has a height h1 larger than the thickness t of the light guide 8 in an area where the heat sink 3 is arranged, as shown in FIG. 5. Further, the projecting portion 22 (inner peripheral surface 22a) has a height h2 larger than the thickness t of the light guide 8 and smaller than the height h1 in an area where no heat sink 3 is arranged, as shown in FIG. 6. The projecting portion 22 (inner peripheral surface 22a) is formed to be parallel to the direction X, as shown in FIGS. 5 and 6. Further, the projecting portion 22 (inner peripheral surface 22a) is formed to be parallel to the light incident side surface 81a and the side surface 82 of the light guide 8. The side surfaces 83 and 84 are formed to be parallel to the projecting portion 22 (inner peripheral surface 22a), similarly to the side surface 82. The thickness of the projecting portion 22 in the extensional direction (direction Y) of the bottom surface 21 is larger than the thickness t of the light guide 8 in the anteroposterior direction.

The TV 100 is so configured that the black resin frame 5 covers a position where the projecting portion 22 (inner peripheral surface 22a) of the white resin frame 2 and the side surface 82 of the light guide 8 are in contact with each other from the front surface side (along arrow X1), as shown in FIG. 6. Further, the TV 100 is so configured that the black resin frame 5 (covering portion of the black resin frame 5) covers positions where the side surfaces 83 and 84 of the light guide 8 are in contact with the projecting portion 22 (inner peripheral surface 22a) of the white resin frame 2 similarly to the side surface 82. In other words, the black resin frame 5 is configured to cover the front surface sides of the side surfaces 82 to 84 of the substantially rectangular light guide 8. A portion of the black resin frame 5 coming into contact with (corresponding to) the front surface (along arrow X1) of the projecting portion 22 of the white resin frame 2 is formed in a planar surface shape. The TV 100 is so configured that the black resin frame 5 covers a portion where the projecting portion (inner peripheral surface 22a) of the white resin frame 2 and the light incident side surface 81a of the light guide 8 are opposed to each other from the front surface side. The bezel 1 made of SECC (made of metal) is formed to extend from the front surface side (along arrow X1) of the black resin frame 5 up to a portion close to the rear surface side (along arrow X2) of the light guide 8 in the anteroposterior direction.

According to this embodiment, as hereinabove described, the TV 100 is provided with the light guide 8 formed in a substantially rectangular shape and having the light incident side surface 81a consisting of the side surface opposed to the LEDs 42. Thus, the LEDs 42 can be arranged on a side portion of the light guide 8, whereby increase in the anteroposterior thickness of the TV body 100a can be suppressed, dissimilarly to a case where the LEDs 42 are arranged on the rear surface side of the light guide 8. Further, the TV 100 is provided with the white resin frame 2 including the inner peripheral surface 22a having high light reflectance and the light guide 8 arranged on the white resin frame 2 in the state where the three side surfaces 82 to 84 other than the light incident side surface 81a are in contact with the inner peripheral surface 22a of the white resin frame 2. Thus, the inner peripheral surface 22a functions also as a reflector inhibiting light incident upon the light guide 8 from leaking out of the side surfaces 82 to 84, whereby reduction in light emission efficiency of the display portion 10 can be suppressed while reducing the number of components without separately providing a dedicated reflector inhibiting the light from leaking out of the side surfaces 82 to 84 of the light guide 8. In this TV 100, therefore, reduction in the light emission efficiency of the display portion 10 can be suppressed while suppressing increase in the anteroposterior thickness of the TV 100 and reducing the number of components without separately providing a dedicated reflector. Thus, increase in the number of components can be suppressed. Further, the light guide 8 is arranged on the white resin frame 2 in the state where the side surfaces 82 to 84 thereof are in contact with the inner peripheral surface 22a of the white resin frame 2, whereby light can be effectively inhibited from leaking out of the side surfaces 82 to 84 of the light guide 8 as compared with a case where the light guide 8 is arranged on the white resin frame 2 while only two side surfaces or one side surface other than the light incident side surface 81a is in contact with the inner peripheral surface 22a of the white resin frame 2. Thus, reduction in the light emission efficiency of the display portion 10 can be suppressed, whereby the number of the LEDs 42 can be reduced.

According to this embodiment, as hereinabove described, the inner peripheral surface 22a of the white resin frame 2 is made of a white material. Thus, the light incident upon the light guide 8 can be effectively inhibited from leaking out of the side surfaces 82 to 84 of the light guide 8 by increasing the light reflectance of the inner peripheral surface 22a.

According to this embodiment, as hereinabove described, the TV 100 is provided with the white resin frame 2 having the bottom surface 21 covering the rear surface of the TV body 100a. Thus, the white resin frame 2 functions also as the rear frame covering the rear surface of the TV body 100a, whereby no dedicated rear frame may be separately provided, and the number of components can be reduced.

According to this embodiment, as hereinabove described, the inner peripheral surface 22a of the projecting portion 22 is formed to extend substantially parallelly with the side surfaces 82 to 84 of the light guide 8 in the anteroposterior direction. Thus, the light guide 8 can be easily arranged on the white resin frame 2 by bringing the side surfaces 82 to 84 thereof into contact with the inner peripheral surface 22a of the projecting portion 22.

According to this embodiment, as hereinabove described, the inner peripheral surface 22a of the projecting portion 22 is configured to be in surface contact with the side surfaces 82 to 84 of the light guide 8. Thus, the side surfaces 82 to 84 of the light guide 8 and the inner peripheral surface 22a of the white resin frame 2 can be brought into contact with each other in a stable state.

According to this embodiment, as hereinabove described, the bottom surface 21 and the projecting portion 22 are integrally formed on the white resin frame 2. Thus, the number of components can be reduced as compared with a case where the bottom surface 21 and the projecting portion 22 are separately provided.

According to this embodiment, as hereinabove described, the projecting portion 22 is configured to have the thickness larger than the thickness t of the light guide 8 in the anteroposterior direction. Thus, the whole side surfaces 82 to 84 of the light guide 8 can be brought into contact with the inner peripheral surface 22a of the white resin frame 2, whereby the light incident upon the light guide 8 can be reliably inhibited from leaking out of the side surfaces 82 to 84 of the light guide 8.

According to this embodiment, as hereinabove described, the light-emitting surface 81b substantially orthogonal to the light incident side surface 81a is provided on the front surface of the light guide 8, and arranged rearward beyond the front surface of the projecting portion 22 of the white resin frame 2 in the anteroposterior direction. Thus, light advancing in the light guide 8 before emission from the light-emitting surface 81b can be effectively inhibited from leaking out of the side surfaces 82 to 84 of the light guide 8.

According to this embodiment, as hereinabove described, the thickness of the projecting portion 22 in the extensional direction of the bottom surface 21 is rendered larger than the thickness t of the light guide 8. Thus, rigidity of the projecting portion 22 can be easily increased.

According to this embodiment, as hereinabove described, the TV 100 is provided with the black resin frame 5 having high light absorptivity for fixing the light guide 8, and the black resin frame 5 is configured to include the covering portion covering the positions where the side surfaces 82 to 84 of the light guide 8 are arranged in the state coming into contact with the inner peripheral surface 22a of the white resin frame 2 from the front surface side. Thus, the covering portion of the black resin frame 5 can shield light even if the same leaks out of the side surfaces 82 to 84 of the light guide 8, whereby the leaking light can be inhibited from leaking toward the front surface side of the TV body 100a.

According to this embodiment, as hereinabove described, the black resin frame 5 (covering portion) is made of the black material. Thus, the black resin frame 5 (covering portion) made of the black material can more effectively shield the light.

According to this embodiment, as hereinabove described, the black resin frame 5 is formed in a frame shape, and configured to cover the front surface sides of the side surfaces 82 to 84 of the substantially rectangular light guide 8. Thus, the frame-shaped black resin frame 5 can shield the light on the whole areas of the front surface sides of the side surfaces 82 to 84 of the substantially rectangular light guide 8, whereby the light can be effectively inhibited from leaking out toward the front surface side of the TV body 100a.

According to this embodiment, as hereinabove described, the TV 100 is provided with the bezel 1 of metal covering the black resin frame 5 from the front surface side, and the bezel 1 is formed to extend from the front surface side of the black resin frame 5 up to the portion close to the rear surface side of the light guide 8 in the anteroposterior direction. Thus, the bezel 1 can inhibit the light from leaking out of the black resin frame 5, whereby the image displayed on the display portion 10 can be prevented from difficulty in visual recognition.

According to this embodiment, as hereinabove described, the front surface side of the projecting portion 22 of the white resin frame 2 is formed in a planar surface shape, and the portion of the black resin frame 5 corresponding to the front surface side of the projecting portion 22 of the white resin frame 2 is at least partially formed in a planar surface shape. Thus, the light can be inhibited from leaking out of a clearance between the black resin frame 5 and the projecting portion 22 of the white resin frame 2 by bringing the black resin frame 5 and the projecting portion 22 of the white resin frame 2 into contact with each other in a stable state.

According to this embodiment, as hereinabove described, the light guide 8 and the white resin frame 2 are made of materials having substantially identical linear expansion coefficients while the inner peripheral surface 22a is formed to have the width larger than the thickness of the light guide 8, and the light guide 8 is arranged on the white resin frame 2 in the state where substantially the whole areas of the side surfaces 82 to 84 are in contact with the inner peripheral surface 22a. Thus, the light guide 8 and the white resin frame 2 expand or contract at substantially identical rates when the same are influenced by heat so that neither the light guide 8 nor the white resin frame 2 remarkably expands to one-sidedly urge the other, whereby the light guide 8 and the white resin frame 2 can be inhibited from misregistration. Further, the light can be further inhibited from leaking out of the side surfaces 82 to 84 by bringing substantially the whole areas of the side surfaces 82 to 84 into contact with the inner peripheral surface 22a.

According to this embodiment, as hereinabove described, the white resin frame 2 is so configured that reflectance thereof is higher than that of the covering portion of the black resin frame 5. Thus, the white resin frame 2 can more reliably inhibit the light incident upon the light guide 8 from leaking out of the side surfaces 82 to 84 of the light guide 8 while the covering portion of the black resin frame 5 can more reliably shield the light, whereby the display portion 10 can be further inhibited from reduction in visual recognizability.

According to this embodiment, as hereinabove described, the black resin frame 5 is formed to extend up to the portion close to the outer edge portion of the white resin frame 2. Thus, the area of the black resin frame 5 can be increased, whereby the black resin frame 5 can reliably shield light even if the light leaks out of the side surfaces 82 to 84 of the light guide 8.

Although the present invention has been described and illustrated in detail, it is clearly understood that the same is by way of illustration and example only and is not to be taken by way of limitation, the spirit and scope of the present invention being limited only by the terms of the appended claims.

For example, while the present invention is applied to the TV (television set) as a display in the aforementioned embodiment, the present invention is not restricted to this. The present invention is also applicable to another display such as a monitor of a PC (personal computer).

While the inner side surface having high reflectance is made of white resin in the aforementioned embodiment, the present invention is not restricted to this. According to the present invention, the inner side surface having high reflectance may alternatively be made of resin of a color (milk-white, for example) other than white, so far as the color is quasi-white. Further alternatively, the inner side surface having high reflectance may be formed by coloring the surface (inner side surface) of the first resin frame white or quasi-white. In addition, the inner side surface having high reflectance may be formed by mirror-finishing the first resin frame.

While the second resin frame of the display according to the present invention is made of black resin in the aforementioned embodiment, the present invention is not restricted to this. According to the present invention, the second resin frame may alternatively be made of resin of a color (dark-gray, for example) other than black, so far as the color is quasi-black. Further alternatively, the second resin frame may be formed by coloring the surface black or quasi-black.

While the side surfaces other than the light incident side surface are in contact with the inner side surface of the white resin frame (first resin frame) in the aforementioned embodiment, the present invention is not restricted to this. According to the present invention, the side surfaces other than the light incident side surface may alternatively be configured to be opposed to a portion close to the inner side surface of the first resin frame. In this case, the side surfaces other than the light incident side surface and the inner side surface of the first resin frame are preferably configured to be opposed to each other at a small interval of not more than 1 mm. Thus, the side surfaces other than the light incident side surface and the inner side surface of the first resin frame can be inhibited from coming into contact with each other and urging each other due to thermal expansion of the light guide, while inhibiting light from leaking out of the side surfaces other than the light incident side surface with the inner side surface of the first resin frame.

While all of the three side surfaces other than the light incident side surface are configured to come into contact with the inner side surface of the white resin frame (first resin frame) in the aforementioned embodiment, the present invention is not restricted to this. According to the present invention, the three side surfaces other than the light incident side surface may alternatively be partially brought into contact with the inner side surface of the first resin frame, and the remaining side surface(s) may be arranged in the vicinity of the first resin frame in a state opposed thereto.

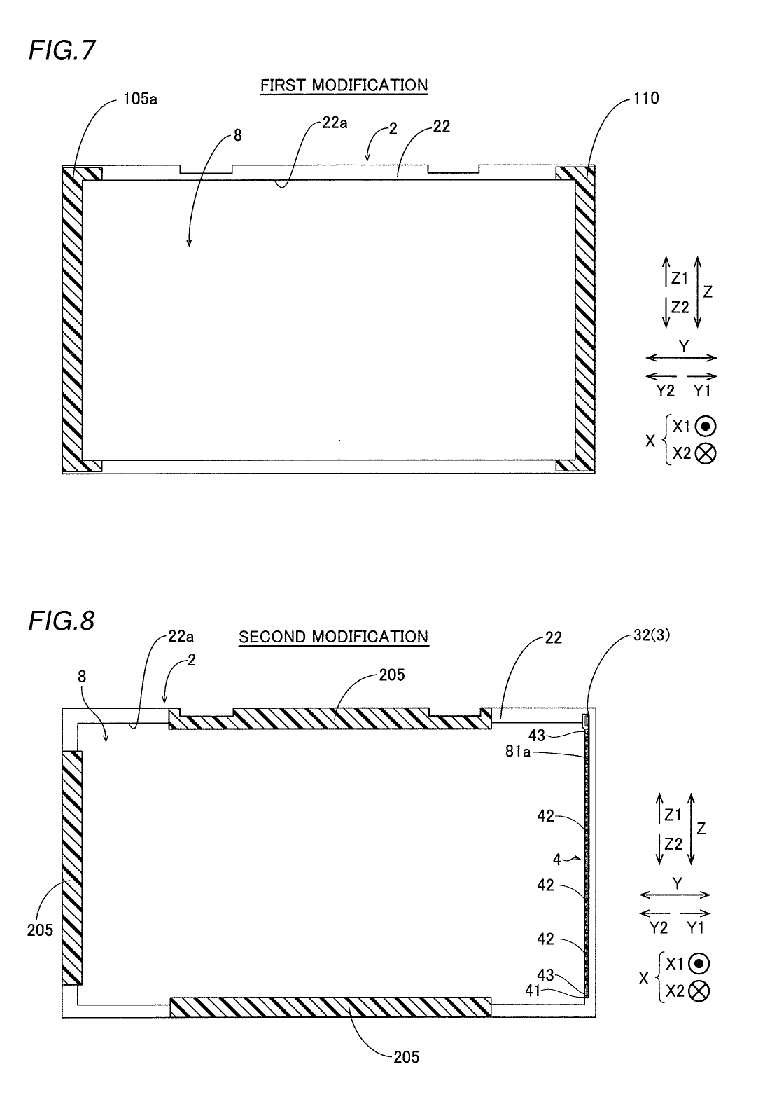

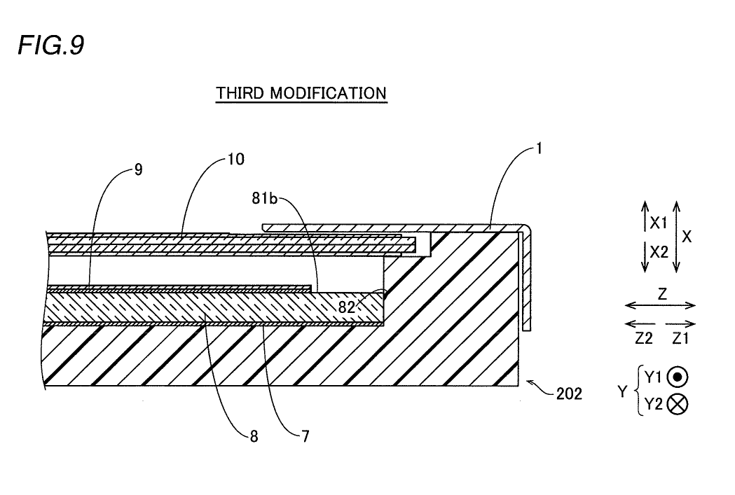

While the TV is provided with the black resin frame (second resin frame) covering all of the positions where the three side surfaces other than the light incident side surface of the light guide are arranged in the state coming into contact with the inner side surface of the white resin frame (first resin frame) in the aforementioned embodiment, the present invention is not restricted to this. According to the present invention, the TV may alternatively be provided with a second resin frame partially covering the positions where the three side surfaces other than the light incident side surface of the light guide are arranged in the state coming into contact with the inner side surface of the first resin frame. More specifically, a TV may be provided with a second resin frame 105a covering a portion corresponding to one side surface among positions where three side surfaces other than a light incident side surface of a light guide are arranged in a state coming into contact with an inner side surface of a first resin frame, as in a first modification shown in FIG. 7. In this case, the TV may be provided with a frame 110 covering a position where the light incident side surface and a light source are opposed to each other. Alternatively, a TV may be provided with a second resin frame 205 partially covering respective portions corresponding to three side surfaces among positions where the three side surfaces other than a light incident side surface of a light guide are arranged in a state coming into contact with an inner side surface of a first resin frame, as in a second modification shown in FIG. 8. According to the present invention, a TV may be provided with no second resin frame, as in a third modification shown in FIG. 9.

What is claimed is:

1. A display comprising:
a display body;
a display portion arranged on a front surface side of the display body for displaying an image;
a first resin frame arranged on a rear surface side of the display body, formed in a substantially rectangular shape and including a frame-shaped inner side surface having high light reflectance;
a light source supplying light to the display portion; and
a light guide formed in a substantially rectangular shape, having a light incident side surface consisting of a side surface opposed to the light source for receiving the light emitted from the light source, and arranged on the first resin frame in a state where three side surfaces other than the light incident side surface are in contact with the inner side surface of the first resin frame or opposed to a portion close to the inner side surface of the first resin frame.

2. The display according to claim 1, wherein
at least the inner side surface of the first resin frame is made of a white or quasi-white material.

3. The display according to claim 1, wherein
the first resin frame has a bottom surface covering the rear surface of the display body thereby constituting a rear frame,
the rear frame includes a frame-shaped projecting portion protruding toward the front surface side along an edge portion of the bottom surface, and
the frame-shaped inner side surface of the first resin frame is included in the frame-shaped projecting portion.

4. The display according to claim 3, wherein
the inner side surface of the frame-shaped projecting portion is formed to extend substantially parallelly with the side surfaces of the light guide in the anteroposterior direction.

5. The display according to claim 3, wherein
the inner side surface of the frame-shaped projecting portion and the side surfaces of the light guide are configured to come into surface contact with each other.

6. The display according to claim 3, wherein
the bottom surface of the first resin frame and the frame-shaped projecting portion are integrally formed on the first resin frame.

7. The display according to claim 3, wherein
the frame-shaped projecting portion has a thickness larger than the thickness of the light guide in the anteroposterior direction.

8. The display according to claim 3, wherein
the light guide includes a light-emitting surface provided on the front surface of the light guide to be substantially orthogonal to the light incident side surface, and
the light-emitting surface is arranged rearward beyond the front surface of the frame-shaped projecting portion of the first resin frame in the anteroposterior direction.

9. The display according to claim 3, wherein
the thickness of the frame-shaped projecting portion in the extensional direction of the bottom surface is larger than the thickness of the light guide in the anteroposterior direction.

10. The display according to claim 1, further comprising a second resin frame having high light absorptivity for fixing the light guide to the display body, wherein
the second resin frame includes a covering portion covering a position where at least one of the three side surfaces of the light guide other than the light incident side surface is arranged in the state in contact with the inner side surface of the first resin frame or opposed to the portion close to the inner side surface of the first resin frame from the front surface side.

11. The display according to claim 10, wherein
at least the covering portion of the second resin frame is made of a black or quasi-black material.

12. The display according to claim 10, wherein
the second resin frame is formed in a frame shape, and configured to cover the front surface sides of the side surfaces of the light guide formed in a substantially frame shape.

13. The display according to claim 10, further comprising a bezel of metal covering the second resin frame from the front surface side, wherein
the bezel is formed to extend from the front surface side of the second resin frame up to a portion close to the rear surface side of the light guide in the anteroposterior direction.

14. The display according to claim 10, wherein
the first resin frame includes a bottom surface covering the rear surface of the display body and a frame-shaped projecting portion protruding toward the front surface side along an edge portion of the bottom surface,
the front surface of the frame-shaped projecting portion of the first resin frame is formed in a planar surface shape, and
a portion of the second resin frame corresponding to the front surface of the frame-shaped projecting portion of the first resin frame is at least partially formed in a planar surface shape.

15. The display according to claim 1, wherein
the light guide and the first resin frame are made of materials having substantially identical linear expansion coefficients, and
the light guide is arranged on the first resin frame in a state where substantially the whole areas of the three side surfaces other than the light incident side surface are in contact with the inner side surface of the first resin frame or opposed to the portion close to the inner side surface of the first resin frame.

16. The display according to claim 11, wherein
the reflectance of the first resin frame is higher than the reflectance of the covering portion of the second resin frame.

17. The display according to claim 10, wherein
the second resin frame is formed to extend up to a portion close to an outer edge portion of the first resin frame.

18. The display according to claim 1, wherein
the display is a television set including a receiver receiving television broadcasting.
